(19) United States
(12) Patent Application Publication
(10) Pub. No.: US 2008/0137342 A1
(43) Pub. Date: Jun. 12, 2008

(54) Delivery beacon

(76) Inventor: Patrick A. Portor, Willoughby, OH (US)

Correspondence Address: Renee S. Rutkowsik, P. O. Box 2184, Arlington, VA, 22202, US

(21) Appl. No.: 11/634,388

(22) Filed: Dec. 6, 2006

(51) Int. Cl. F21V 23/04

(52) U.S. Cl. 362/295

(57) ABSTRACT

This invention relates to a light or beacon useful for indicating location of a residence or vehicle such as car, boat, trailer, or the like. The device is easily mountable, operable manually or remotely, and which device is useful for indicating position of a residence, business or vehicle or the like in remote or crowded location for simple identification of the house or vehicle from a somewhat remote position, or for delivery or emergency services, and whereby additional information may be simply and effectively communicated for such delivery or emergency or other needs.

### BACKGROUND OF THE INVENTION

1. Field of the Invention

This invention relates to a light or beacon useful for indicating location of a residence or vehicle such as car, boat, trailer, or the like. More particularly, the invention relates to a device which is easily mountable, operable manually or remotely, and which device is useful for indicating position of a residence, business or vehicle or the like in remote or crowded location for simple identification of the house or vehicle from a somewhat remote position, or for delivery or emergency services, and whereby additional information may be simply and effectively communicated for such delivery or emergency or other needs.

2. Description of the Prior Art

Illuminating indicators for emergency purposes are known in the prior art. For example, U.S. Pat. No. 4,611,265 issued to Davis discloses an address display system in which the house numerals are disposed on a translucent wall illuminated by a conventional internal bulb. A flashing emergency light is also disposed within the housing. The emergency light may be actuated by the occupant by a remote switch within the residence to notify passersby to warn passers-by of the need for assistance. Harper U.S. Pat. No. 4,587,753 provides an indicia display system which flashes a red light to warn of an emergency situation within the house.

An emergency indicator system requiring no manual switch activation is shown in Leighton et al U.S. Pat. No. 5,012,507 whereby the dialing of emergency telephone numbers activated a strobe light or flashing light installed on the exterior of the premises. McMinn et al U.S. Pat. No. 4,993,058 uses the dialing of the 911 emergency code to activate a strobe warning light disposed inside a cubical address display.

A portable alarm apparatus is shown in Foster U.S. Pat. No. 5,587,704 where the alarm apparatus, having both an audible alarm and a visible alarm, plugs into an electrical wall outlet, with battery back-up, is activated by remote radio transmitter to generate an emergency signal.

A property address indication device is shown in Cathel U.S. Pat. No. 6,299,325, wherein the device is mounted in top of a mailbox, and is powered by battery or solar photosensitive cell and indicia on at least one sidewall of the device.

Determining the location of a residence can be seen as a simple task. One reads the address displayed on the front of a residence, as in a house or apartment building, or one reads the address stenciled on a mailbox placed at the foot of a driveway in a suburban enclave, or at the roadside, in a more rural setting. Varying circumstances can make the task of locating a residence more daunting.

Night, and lack of bright illumination, can make reading addresses difficult. Numbers on the front of a house or apartment building may be obscured by dim lighting, or by display of the information far from the light fixture.

Poorly displayed information, or badly lighted structures can make locating a particular address difficult in a neighborhood of similar structures, such as on an urban street, or in an apartment complex. Townhouse developments, some having numerous cul-de-sac street layouts, with similar sounding names, and homes of very similar design, can be problematic in locating a desired home or address. Office parks, or low-rise office developments can present similar challenges in finding the correct address.

Rural environments can present particular challenges in locating the desired destination. While a mailbox can provide some indication of location, as it is often located near the entrance to the road or driveway leading to the home or rural business, the location itself can lie far from the road, among other outbuildings, or hidden from the road by trees or crops. In some rural locations, mailboxes are located in clusters by the roadside, providing no specific direction to the desired location, whether home or business.

The inability to locate the desired destination can be frustrating to the seeker of the home or business. Risks and losses more serious than frustration can flow from the inability to locate a desired destination. From a commercial perspective, the time lost by delivery personnel in the hunt for the correct delivery location contributes to slower delivery times, and the resulting necessity to employ greater numbers of personnel, and thus higher costs for business and delivery services alike. The potential exists for loss of sales due to the afore-mentioned frustrations, resulting in the customer or business contact leaving without finding the desired destination, or arriving with an uncooperative attitude, from the frustration of the almost-lost experience.

The search for a particular address can result in traffic disruption, as the individual seeking a particular location slows to a crawl to examine the information displayed or buildings, signs or mailboxes. Persons behind the address seeker must also slow their speed, resulting in the flow of traffic being impeded, and increasing the likelihood that drivers will undertake risky and unsafe maneuvers. Such unsafe maneuvers can result in aggressive driving, causing accidents resulting in property damage and personal injury.

The inability to locate a particular destination can have disasterous effects to the health of persons, as in an emergency situation where rescue squad or fire services have been summoned, wherein the expedient arrival of said emergency services can mean the difference between life and death.

### OBJECTS OF THE INVENTION

It is an object of the present invention to address the aforementioned needs and disadvantages by providing an apparatus for facilitating the locating of a desired residence, business or the like.

It is also an object of the invention to provide apparatus for signaling information for specific purposes, as for the arrival of particular commercial personnel or for municipal or governmental services.

It is also an object of the invention to provide apparatus for providing assistance in locating a particular location which can be installed and maintained with minimal technical expertise or skill, thus providing an affordable and accessible assistance device to persons in homes and businesses everywhere.

### SUMMARY OF THE INVENTION

The present invention seeks to satisfy the aforementioned needs by providing an inexpensive and easily operated apparatus for indicating the location of a desired destination by light means. The novel apparatus comprises a housing having a light source in its interior, powered by a battery or other source, an opaque lens through which the illumination from the light source is visible to passersby, and a switch to turn the light means on and off. In a preferred mode, the opaque lens of the housing is colored all or in part, or equipped with colored designs or symbols to communicate information to passersby.

### BRIEF DESCRIPTION OF THE DRAWINGS

The invention may be best understood by those having ordinary skill in the art by reference to the following detailed description when considered in conjunction with the accompanying drawings in which:

FIG. 1 is a perspective view of the basic embodiment of the delivery beacon apparatus of the invention;

FIG. 2 is a perspective view of an alternate embodiment having panels of different colors for communicating to various service providers;

FIG. 3 is a perspective view of an alternate embodiment showing multiple panels or lenses which communicate by word or symbol to service providers

FIG. 4 is a perspective view showing an embodiment of the invention in which the delivery beacon itself is in the shape the service to be communicated with, as a school bus;

FIG. 5 is a perspective view of the interior of the delivery beacon;

FIG. 6 is an interior view of an alternative embodiment showing multiple panels or lenses, and

FIG. 7 is a side view, partially in section, of the present invention.

FIG. 8 is an alternative embodiment, shown from a front perspective view.

### DETAILED DESCRIPTION OF THE INVENTION

Referring to the drawings, FIG. 1 shows the delivery beacon 10. The delivery beacon 10 comprises a housing 11 having a front wall 12 and a back wall 13, top wall 14, bottom wall 15, and side walls 16 and 17. Disposed in front wall 12 is opaque lens 18, in a single color. The particular size of said walls is variable, but are such that the beacon device is light weight, easily portable, and attachable to a desired surface.

Front, back, side, top and bottom walls may be made of light weight plastic or metal, wherein such materials are suitable for being out of doors and exposed to the elements. Front wall 12 contains opaque lens 18, which is preferably formed of a lightweight plastic, but which may be formed of glass.

The opaque lens may be formed of conventional white translucent material. It may also be formed of colored plastic, to indicate particular information, such as an emergency, or the like.

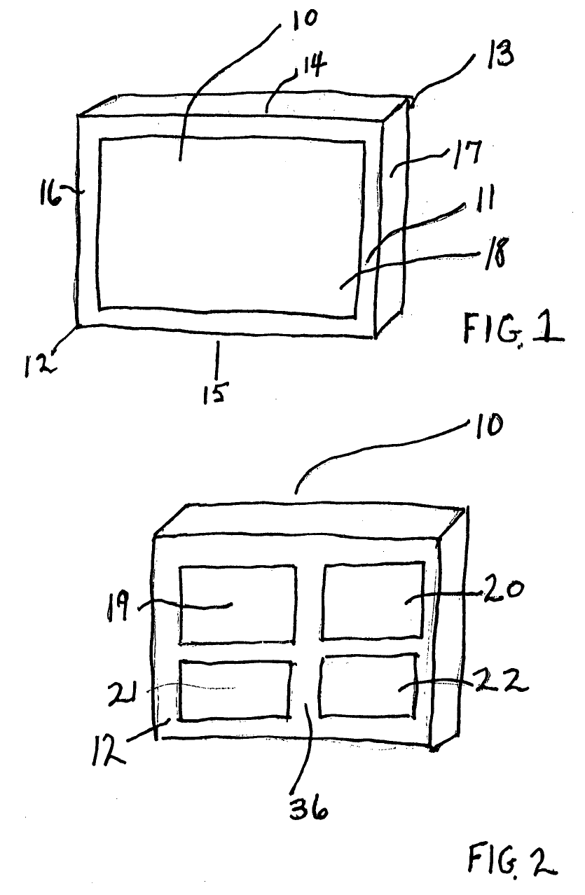

In reference to FIG. 2, the delivery beacon 10 has in front wall 12 an opaque lens 18 displaying multiple colors, 19, 20, 21, and 22, said colored panels of equal sizes, dividing opaque lens into four sections. The opaque lens may include a grid structure 36 on its surface. The grid structure divides the various colors of the opaque lens. The grid may be formed as an integral piece of front wall 12, or it may be an add-on structure which may be formed to one skilled in the art, to be snapped onto the front wall of the beacon device.

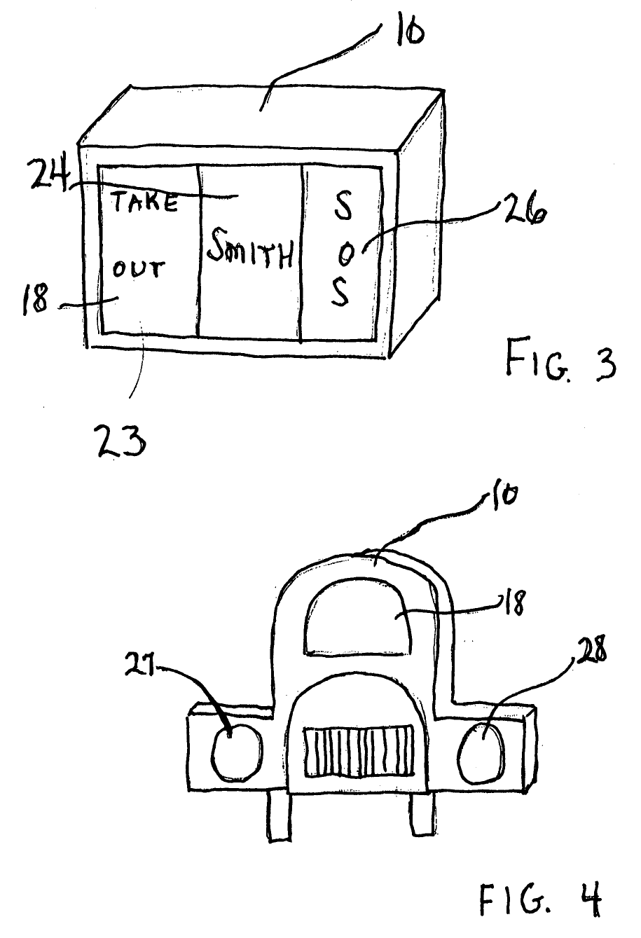

FIG. 3 shows a perspective view of another embodiment of the novel delivery beacon 10 where opaque lens 18 is divided into three sections, wherein each section bears symbols for particular services, as in take-out food 23, name of the resident 24, and a signal for emergency services 26. The multiple sections can be formed as an integral part of the front wall, or as sections, which may be removed and replaced, by snap on structure, optional peel-and-stick decals, or other means known to persons skilled in the art.

FIG. 4 shows the delivery beacon 10 with housing 11 formed in a fanciful shape, and wherein colored portions 27 and 28 of the opaque lens 18 are used to signal to the transportation services used by the residents. The delivery beacon can be formed in a rectangular form, as shown in FIGS. 1, 2, 3, or in the artful form. Illustrated in FIG. 4 is a school bus, with intended use for communicating with a school bus, or similar transportation medium.

The communication device of the instant invention may be used in a house environment, for the home owner to communicate with a person driving to or by the home. For example, should the home owner desire to alert the school bus to pick up the child, one of the lights can lighted, as with a green lens at 27. Should the homeowner desire to have the school bus not pick up the child, the opposite lens, 28, in red.

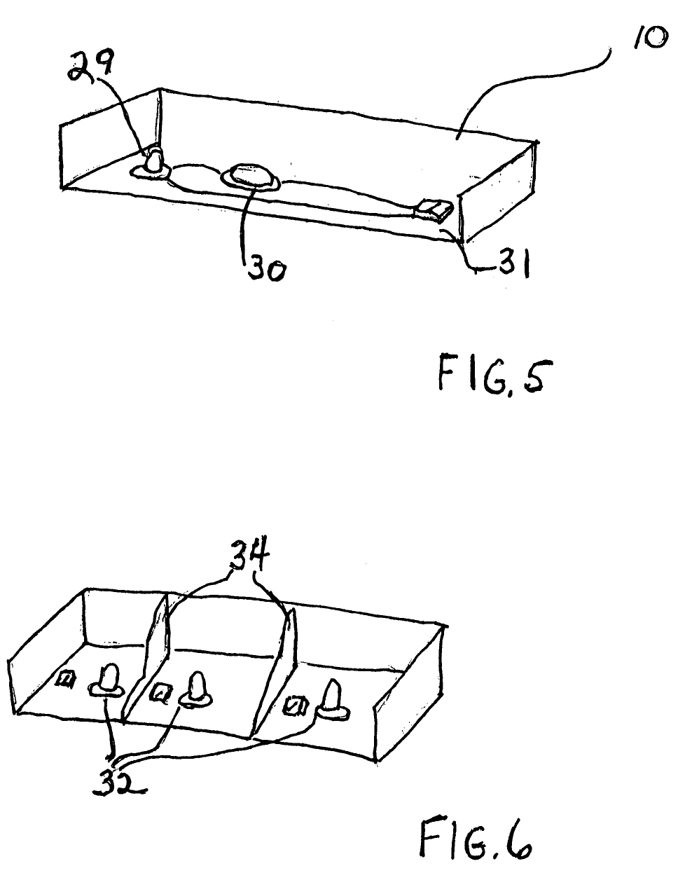

FIG. 5 illustrates an interior view of the delivery beacon 10 of FIG. 1, showing the light source 29, battery power source 30, activating switch 31. Similarly, the device can be operated manually by an on-off switch, the device may be operated by remote switching device, as by radio, GPS, or other signaling means.

In reference to FIG. 6, delivery beacon 10 of FIG. 3 is shown in an interior view, illustrating multiple light sources 32, multiple switches 33, and sectional dividers 34, as in the interior of the inventive apparatus with several or multiple signaling means.

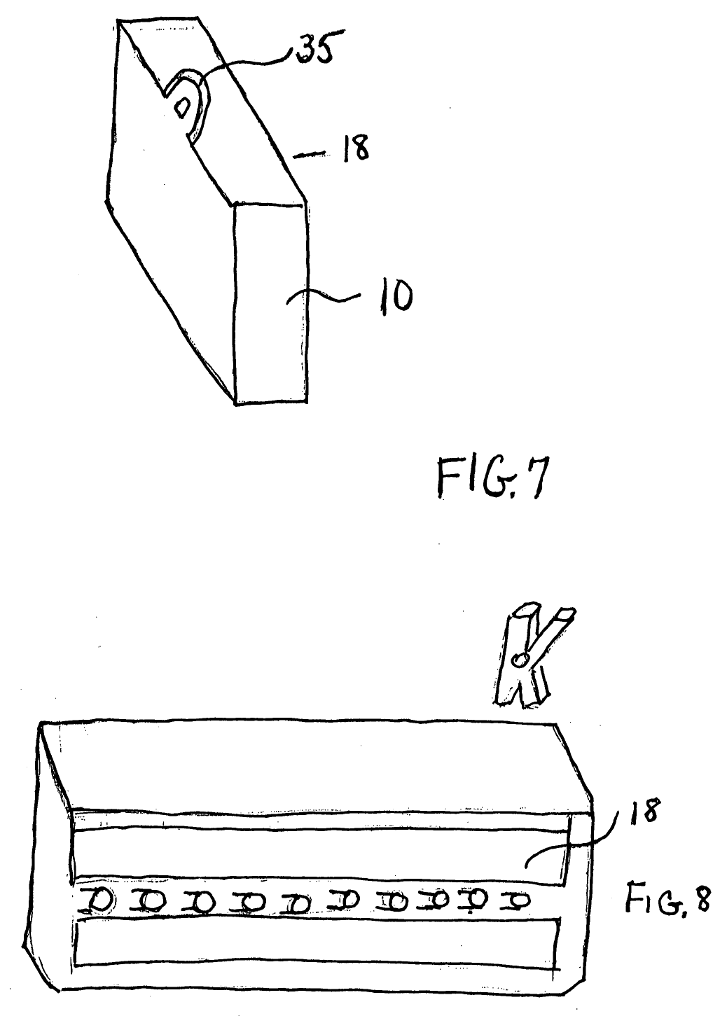

FIG. 7 shows a partial side view of the delivery beacon 10 and illustrates means 35 for securing the beacon to its display position. The illustrated means are a molded loop in the back wall, which may be secured to the supporting surface by conventional hardware, including magnet, suction, or hardware for picture hanging.

FIG. 8 shows the delivery beacon 10 wherein the beacon is equipped with multiple light structures 36, which protrude through the front of the lens 18. Onto the protruding light structures can be snapped on, or impaled, numbers, or letters, to provide indicia desired by the homeowner for communication to others, thus providing an opportunity to list the name, house numbers, or other brief message.

The light device, at 29, may be conventional small bulbs, LEDs, or others as desired, including fiber optic cable, which may be equipped to display changing colors.

The device may be displayed on the home, as on a door, on the interior or exterior of a window, or hung an exterior structure, as a porch railing. As the inventive device may be hardwired to use conventional alternating current, or can be wired to use a batter or set of batteries as a source of power, the device may be used in locations other than the house. In suburban or rural environments, the beacon can be displayed apart from the structure of the house, as on a mailbox, or displayed on a tree, or a fencepost along the driveway or other post.

Further, the device may be utilized in a boating environment, for communication to persons seeking to locate a boat, the device may be positioned on the side of a boat, or a mast, or on a marina structure.

The device is useful in the arena of recreational or camping vehicles, where the communication of location to visitors or to service personnel, can be of vital importance. Similarly, the beacon device may be used in an auto or truck, to communicate for service, or for assistance, in an emergency.

The device is of use in a domestic arena, apart from commercial use. To the “latch-key” child, left at home, and to the parents of such child, the instant device can provide an essential element of security. For the child at home, the instant device provides a way to communicate to a neighbor in a “help” or “I'm ok”, whether the child is in times of uncertainty, or whether a neighbor has inquired as to the child's welfare.

While there have been describes what are considered to be preferred embodiments of the present invention, it will be readily appreciated by those skilled in the are that modifications can be made without departing from the scope of the teachings herein. For example, while the above description has proceeded largely along the lines of a delivery beacon in a generally rectilinear shape, the beacon can be formed in any geometric shape, or likeness of animal, holiday form, or communications symbol or indicia, as by illustration, without departing from the scope of the invention. It is to be understood that all matter herein set forth is to be interpreted as illustrative and not limiting.

What is claimed is:

1. A delivery beacon apparatus for indicating the physical location of a destination comprising
a housing having a front wall, and back wall, top, bottom and side walls, said front wall having disposed therein an opaque lens;
a light means, which when illuminated, casts light through the lens, to be seen by passersby of the device,
switch means for activating the light,
power means for supplying power to the light means;
means for attaching the delivery beacon apparatus to a support.

2. The apparatus according to claim 1, wherein said power means comprises a battery.

3. The apparatus according to claim 1, wherein said power means is an AC circuit, with wiring, such that the delivery beacon can be plugged into household current.

4. The apparatus according to claim 1, wherein the switch means for activating the light may be a manual switch attached to the light circuit.

5. The apparatus according to claim 1, wherein the switch means for activating the light is operated remotely.

6. The apparatus according to claim 5, wherein the switch means is activated by means chosen from among the group comprising a telephone, a radio, satellite, a global positioning device, and RF waves.

7. The apparatus according to claim one wherein the means for attaching the delivery beacon to a mounting are selected from the group comprising suction mechanism, magnetic means, Velcro, conventional hardware.
